(19) United States
(12) Patent Application Publication
(10) Pub. No.: US 2014/0331543 A1
(43) Pub. Date: Nov. 13, 2014

(54) Ice Fishing Tip-Up and Gadget Holder System, Kit and Method

(71) Applicant: Robin Hancock, Elkhorn, WI (US)

(72) Inventor: Robin Hancock, Elkhorn, WI (US)

(21) Appl. No.: 14/276,775

(22) Filed: May 13, 2014

Related U.S. Application Data
(60) Provisional application No. 61/822,725, filed on May 13, 2013.

(51) Int. Cl. A01K 97/01

(52) U.S. Cl. CPC A01K 97/01
USPC 43/17; 43/54.1; 43/21.2

(57) ABSTRACT

A system, kit and method for organizing and securing devices such as ice fishing equipment, in a cylindrical receptacle. The system includes at least one web, but preferably includes two webs of material having different diameters but each having an array of apertures such that when aligned and placed in a receptacle, the two webs may be used to support and carry items in a secure and organized fashion. Further contemplated are other mountable devices capable of holding elongate items for attachment to the cylindrical receptacle and/or a wall mount.

### RELATED APPLICATIONS

This application claims the benefit of co-pending U.S. Provisional Patent Application Ser. No. 61/822,725, filed on 13 May 2013.

### BACKGROUND OF THE INVENTION

Ice fishing has long been a sport that involves patience and skill. It also requires the fisher to carry much bulky equipment out onto the ice. Such equipment may include tip-ups, fishing poles, nets and the like, which may easily become entangled during transportation or worse, be dropped on the ice along the way to the fishing spot, where the items may then be damaged by another fisher or by vehicles driven on the ice. It is not uncommon for the fisher to spend valuable fishing time untangling a mess of fishing line and tip-ups or fixing equipment that has been damaged as it bounced around on the trip out to the ice fishing hole.

### SUMMARY OF THE INVENTION

The present invention is directed to a method and system of devices for use in storing and transporting elongate articles such as fishing poles and the like, to thereby reduce tangling of or damage to the articles being carried. The present system provides a web or webs having apertures therein to receive such items. The system further contemplates the use of two webs having different diameters that may be laterally spaced and friction fit inside a five gallon pail or similar receptacle. Each web preferably includes various spaced apertures that, when aligned with apertures in a second web, provide stable storage for fishing tools during transport. The spaced apertures allow for facile storage and transportation of elongate and other items and further help to prevent entanglement or undue jostling during transport. This feature further reduces damage of the items. The present system further contemplates the addition of removably attachable article holders, which may be attached to the pail or to a wall mount.

The present invention contemplates a system for containing ice-fishing equipment in a tapered receptacle having a circular cross section, the system comprising: a first web comprising a first disc having a first plurality of apertures, the first disc having a substantially circular shape, a first outer periphery, and a first disc diameter; and a second web comprising a second disc having a second plurality of apertures, the second disc having a substantially circular shape, a second outer periphery, and a second disc diameter, wherein the first disc diameter is larger than the second disc diameter. The first plurality of apertures is alignable with the second plurality of apertures when the first web and the second web are secured. within the receptacle. The system may further include means for securing the webs inside the receptacle. Such means may include a plurality of teeth located on the first outer periphery and a plurality of teeth located on the second outer periphery. Alternative means to secure the webs may include a first channel located on the first outer periphery and a second channel located on the second outer periphery, wherein the first and second channels each include a bead therein. Another alternative means may include a plurality of screw bosses located on the first outer periphery and a plurality of screw bosses located on the second outer periphery.

The first disc diameter and the second disc diameter differ to provide lateral spacing of the webs when the first web and the second web are secured within the receptacle. At least one of the first plurality of apertures and at least one of the second plurality of apertures is sized and configured to receive an elongate object. The elongate object may be an ice fishing tip-up, a fishing pole, or other like object.

The system may further include a rod holder having a cylindrical body with a first end, and a first rod holder clip, wherein the first rod holder clip is adapted for removable attachment to a rim of the receptacle. The rod holder may further include a second rod holder clip adapted for removable attachment to at least one of the first plurality of apertures.

The system may further include a container holder having a container holder clip, adapted for removable attachment to a rim of the receptacle.

The present invention further contemplates a kit to be used for transporting ice fishing equipment, the kit comprising:

a first web comprising a first disc having a plurality of apertures, the first disc having a substantially circular shape, a first outer periphery, and a first disc diameter; a second web comprising a second disc having a plurality of apertures, the second disc having a substantially circular shape, a second outer periphery, and a second disc diameter; and a tapered receptacle having a circular cross section.

The kit may further include a rod holder, having a cylindrical body with a first end, and a first rod holder clip; and a container holder including a container holder clip.

The present invention further includes a method for containing ice-fishing equipment in a tapered circular receptacle; the method may include the steps of

providing a first web, the first web comprising a first disc having a first plurality of apertures, the first disc having a substantially circular shape and a first disc diameter;

providing a second web, the second web comprising a second disc having a second plurality of apertures, the second disc having a substantially circular shape and a second disc diameter, wherein the first disc diameter is larger than the second disc diameter;
inserting the second web into the receptacle;

inserting the first web into the receptacle;

laterally spacing apart the first web from the second web;

aligning the first plurality of apertures with the second plurality of apertures;

providing a rod holder, the rod holder having a cylindrical body, with a first end, and a first rod holder clip; and

removably attaching the first rod holder clip to a rim of the receptacle.

Further method steps may include: providing the rod holder with a second rod holder clip; removably attaching the second rod holder clip to one of the first plurality of apertures; providing a container holder having a container holder clip; and removably attaching the container holder clip to a rim of the receptacle.

### BRIEF DESCRIPTION OF THE DRAWINGS

FIG. 1 is a perspective view of an embodiment of a web for use in a system according to the present invention.

FIG. 2 is a top view, a bottom view being identical, of the web of FIG. 1.

FIG. 3 is an end view of the web illustrated in FIGS. 1 and 2.

FIG. 4 is a perspective view of a system including a pair of the webs illustrated in FIG. 1 in place in a pail and with the apertures in relative alignment.

FIG. 5 is a cross-sectional view of the pail shown in FIG. 4, taken along line 5-5 thereof and showing various fishing tools in phantom as supported by the system.

FIG. 6 is a top view, the bottom view being identical, of a second embodiment of a web for use in a system according to the present invention.

FIG. 7 is a side elevation view of the web illustrated in FIG. 6.

FIG. 8 is a too view, the bottom view being the identical, of a third embodiment of a web for use in a system according to the present invention.

FIG. 9 is a side elevation view of the web of FIG. 8.

FIG. 10 is a perspective view of a fourth embodiment of a web for use in a system according to the present invention.

FIG. 11 is a perspective view of a fifth embodiment of a web for use in a system according to the present invention.

FIG. 12 is a perspective view of a rod holder for use in a system according to the present invention.

FIG. 13 is a fragmentary side view of the rod holder illustrated FIG. 12 attached to the rim of a pail and including a web.

FIGS. 14A and 14B illustrate the rod holder of FIG. 12 attached to a wall mount.

FIG. 15 is a perspective view of a system including the rod holder illustrated in FIG. 12 in place for use on the rim of a pail and a web inside the pail.

FIG. 16 is a perspective view of the system illustrated in FIG. 15, but showing the rod holder in the web for transport.

FIG. 17 is a perspective view of an angled rod holder for use in a system according to the present invention.

FIG. 18 is a perspective view of a system including the angled rod holder illustrated in FIG. 17 in place for use on the rim of a pail and a web inside the pail.

FIG. 19 is a perspective view of a container holder for use in a system according to the present invention.

FIG. 20 is a perspective view of a system including the container holder illustrated in FIG. 19 in place for use on the rim of a pail and a web inside the pail.

FIG. 21 is a perspective view of another embodiment of a web for use in a system according to the present invention.

FIG. 22 is a perspective view of another embodiment of a web for use in a system according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

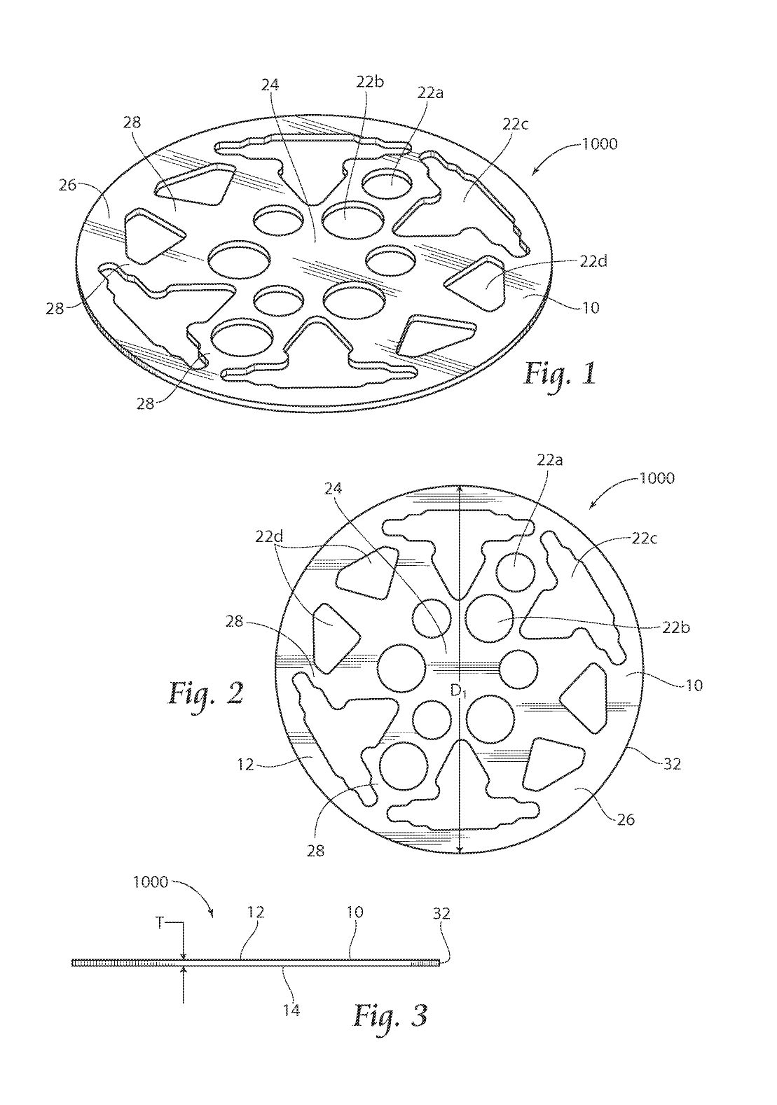

FIG. 1 illustrates a first embodiment 1000 of a web for use in a system according to the present invention. The web 1000 preferably comprises a disc 10 having a first surface 12 and a second surface 14 (see FIG. 3), a plurality of first apertures 22a, a plurality of second apertures 22b, a plurality of third apertures 22c, and a plurality of fourth apertures 22d.

The disc 10 has a predetermined diameter D1 (see FIG. 2) and a thickness T (see FIG. 3) defining a peripheral surface 32. The plurality of first, second, third, and fourth apertures 22a-d comprise various shapes and are spaced around and extend through the disc 10.

The apertures 22a, 22b, 22c, 22d are preferably adapted to receive various types of fishing equipment (see FIG. 5). For example, apertures 22a, 22b are generally circular and are preferably dimensioned to receive variously sized fishing pole handles 44 or other elongate equipment having a handle in or narrow body such as ice-scoops or chisels (not shown) by way of none-limiting example.

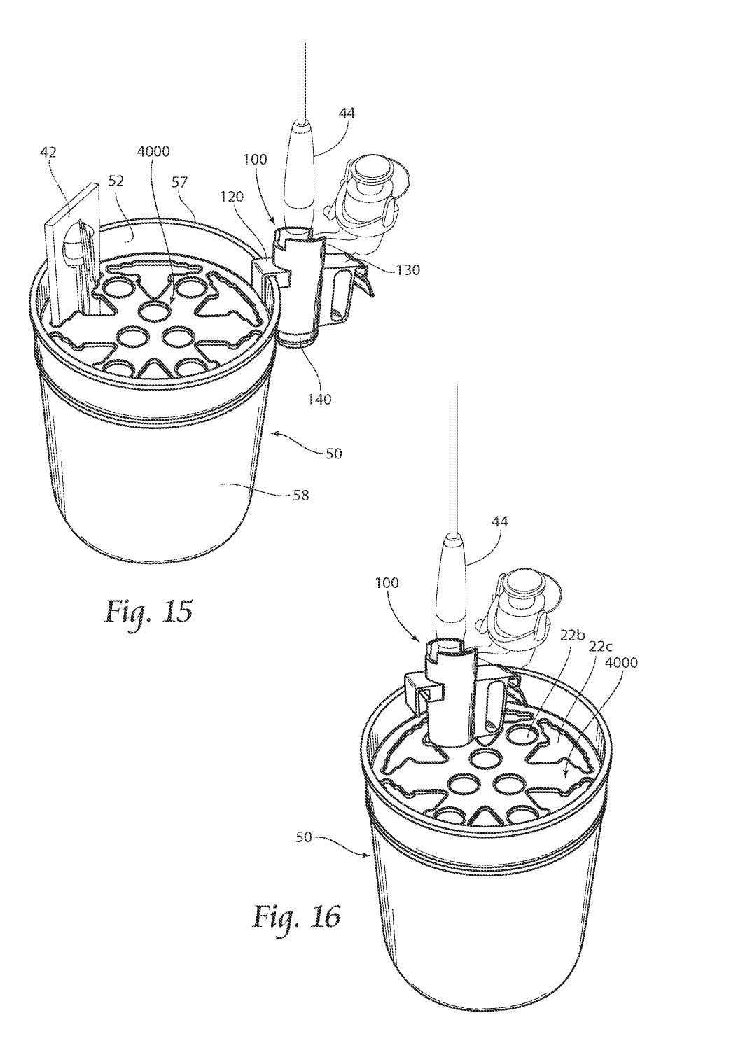

Apertures 22c are preferably sized and configured with an irregular, somewhat t-shape, to accommodate and receive ice fishing tip-ups, more particularly, tip-ups having a collapsed profile similar to that of tip-ups 42 distributed under the BEAVER DAM TIP-UP® name (see for example FIG. 15). Apertures 22d are preferably sized and configured with an irregular, somewhat triangular shape to accommodate and receive tip-ups having other collapsed profiles, such as tip-ups distributed under the Heritage Tackle “Laker” name (not shown). It should be noted that reference to certain styles of tip-ups is for illustrative purposes only, and it is to be understood that it is within the scope of the present invention to include apertures 22c, 22d having other configurations suitable to receive and support tip-ups of various styles and manufacture. Further, although the shapes of apertures 22c and 22d may accommodate the ice fishing tip-ups mentioned, it is within the scope of the present invention to utilize the apertures 22c, 22d to transport other gear, as desired.

With specific reference to FIG. 1, it may be seen that the web 1000 is preferably interconnected and contiguous between apertures 22a, 22b, 22c, 22d; wherein each of the plurality of apertures 22a, 22b, 22c, 22d is completely contained within the disc 10. Further, the disc 10 preferably comprises a center section 24, an outer portion 26, and a plurality of merging points 28.

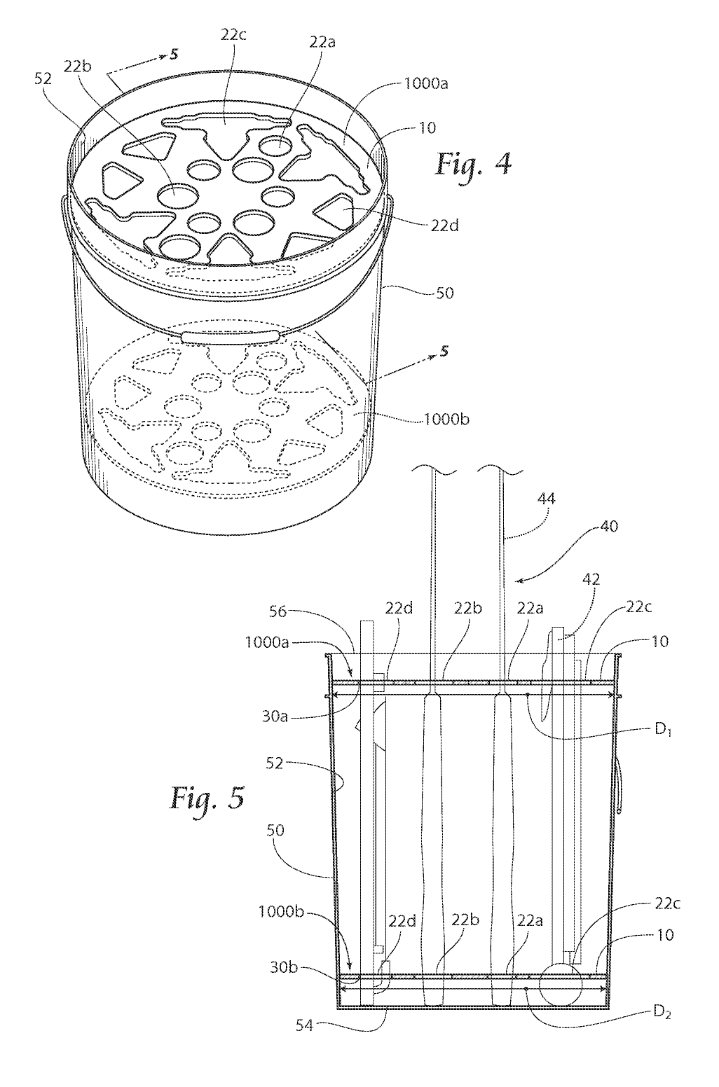

With reference now to FIGS. 4 and 5, a pair of webs (upper web 1000a and lower web 1000b) is shown installed in a container, here a five-gallon pail 50. Many containers such as five-gallon pails 50 have a slight taper from the open end 56 to the closed end 54. Therefore, it may be preferable to provide the lower web 1000b with a diameter D2 that is slightly smaller than the diameter D1 of the upper web 1000a to ensure a tight friction fit. Further, when installed, the plurality of apertures 22a, 22b, 22c, 22d in the upper web 1000a are axially aligned with the plurality of apertures 22a, 22b, 22c, 22d of the lower web 1000b.

FIG. 5 illustrates a system having webs 1000a, 1000b inserted into and aligned in a pail 50 with fishing equipment 40 received by the plurality of aligned apertures 22a, 22b, 22c, 22d. The webs 1000a, 1000b are preferably held in place by friction between the periphery 32 of the webs 1000a, 1000b and the inner surface 52 of the pail 50. Furthermore, the interconnected design of the webs 1000a, 1000b reduces undesirable deformation of the disc 10 when installed and during use, since deformation hampers the installation and the alignment the webs 1000a, 1000b and their apertures 22a, 22b, 22c, 22d. When the webs 1000a, 1000b and their apertures 22a, 22b, 22c, 22d are properly aligned, the webs 1000a, 1000b effectively engage and support the stored items 40 at two locations, one at each were 1000a, 1000b. The two points of contact 30a, 30b significantly reduce the likelihood that the items 40 will fall or become entangled with other items 40.

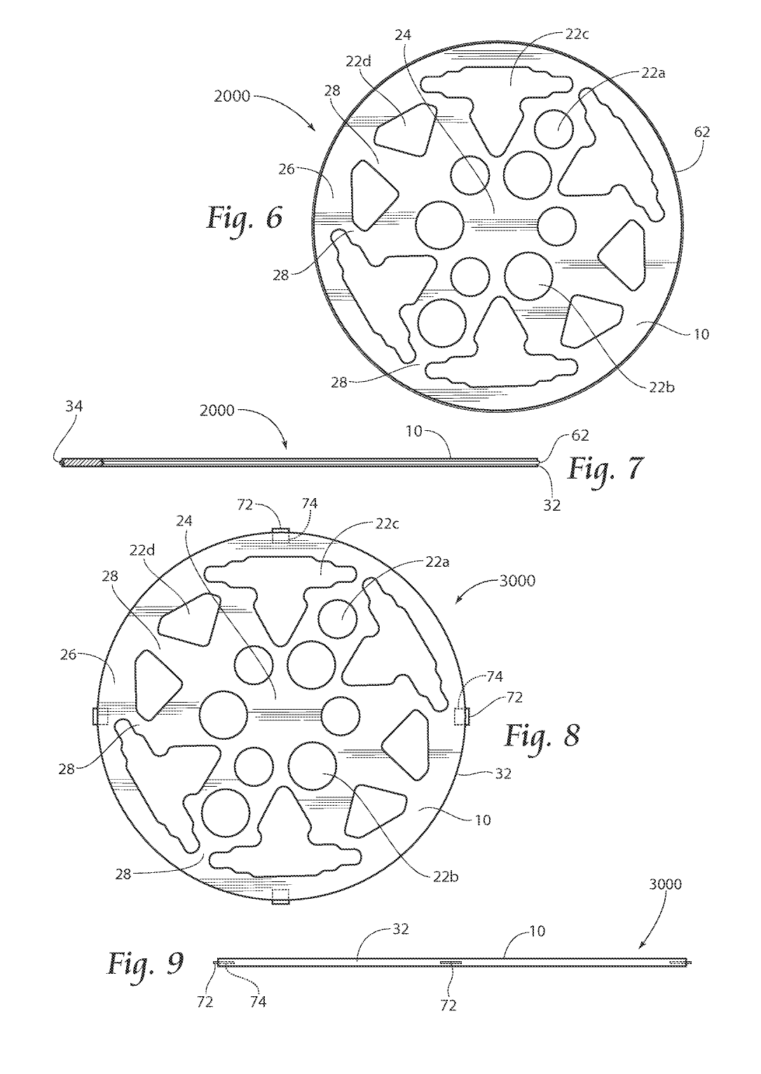

Turning now to FIGS. 6 and 7 another embodiment of a web 2000 for use with the present system is shown. As seen, the web 2000 includes a bead 62 inserted in a channel 34 along the peripheral surface 32 of the disc 10. The bead 62 may be fabricated of any ferrous or non-ferrous material having the rigidity and durability necessary to engage the pail inner surface 52 (see FIG. 5). The bead 62 provides an alternative friction element to positively engage the web 2000 with the inside surface 52 of the pail 50.

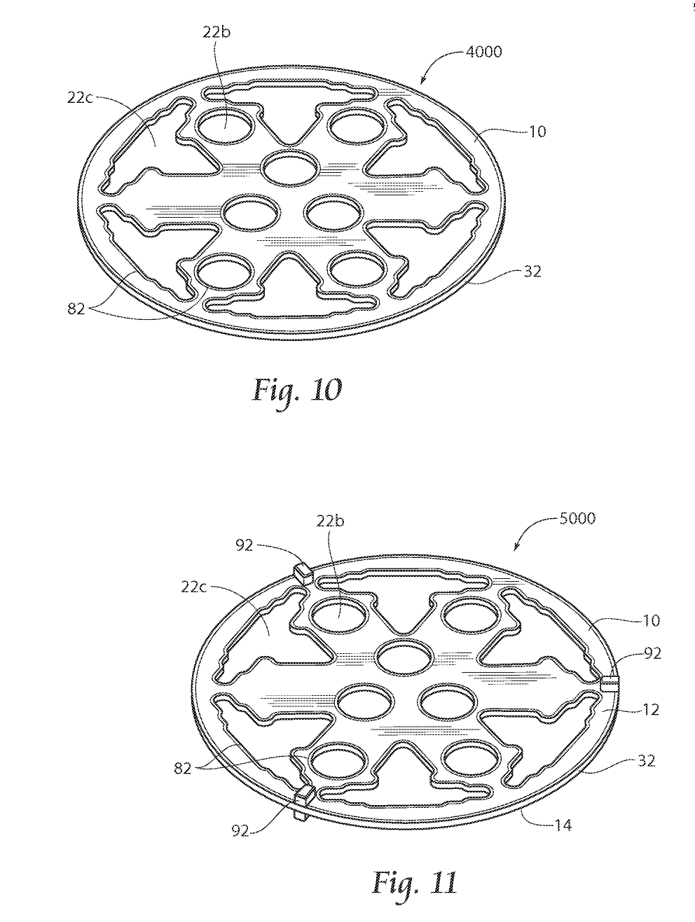

FIGS. 8 and 9 illustrate another embodiment of a web 3000 for use with the present system. The web 3000 includes a plurality of teeth 72 within recesses 74 along the periphery 32 of the disc 10. Similar to the bead 62 shown in FIGS. 6 and 7, the teeth 72 provides an alternative friction element for positive contact with the pail inner surface 52. The plurality of teeth 72 may comprise a ferrous or non-ferrous material, or other suitably rigid material. During installation of the web 3000 into the pail 50, the teeth 72 distort upward and against the pail inner surface 52. When installed, any upward motion of the web 3000 will cause the teeth 72 to further engage with the pail inner surface 52, thus reducing the potential for displacing or even removal of the web 3000 during normal use.

FIG. 10 shows another embodiment 4000 of the web for use with the present system. The web 4000 illustrated in FIG. 10 comprises a plurality of apertures 20b, 20c wherein the peripheries of the apertures 22 and the periphery 32 of the web 4000 include a raised lip or ridge 82. The ridge 82 may be approximately the same thickness T as the web 1000, while the disc 10 has a relatively reduced thickness. The ridges 82 provide rigidity to the disc 10 while reducing the amount of material need for manufacture of the disc 10.

FIG. 11 illustrates another embodiment 5000 for use with the present system. As shown, the web 5000 is substantially similar to the web 4000 illustrated in FIG. 10, however additionally or alternatively, screw bosses 92 may be positioned around the periphery 32 of the disc 10. As maw be seen, the screw bosses 92 are laterally extending from the first disc surface 12 and the second disc surface 14 and may be placed approximately 120 degrees apart. The screw bosses 92 are further preferably located at merging points 28 between two neighboring apertures 22c. Set screws (not shown) may be turned through the screw bosses 92 to at least abut the inner surface 52 of the pail 50 (see FIG. 5) to thereby further secure the web 5000 in place.

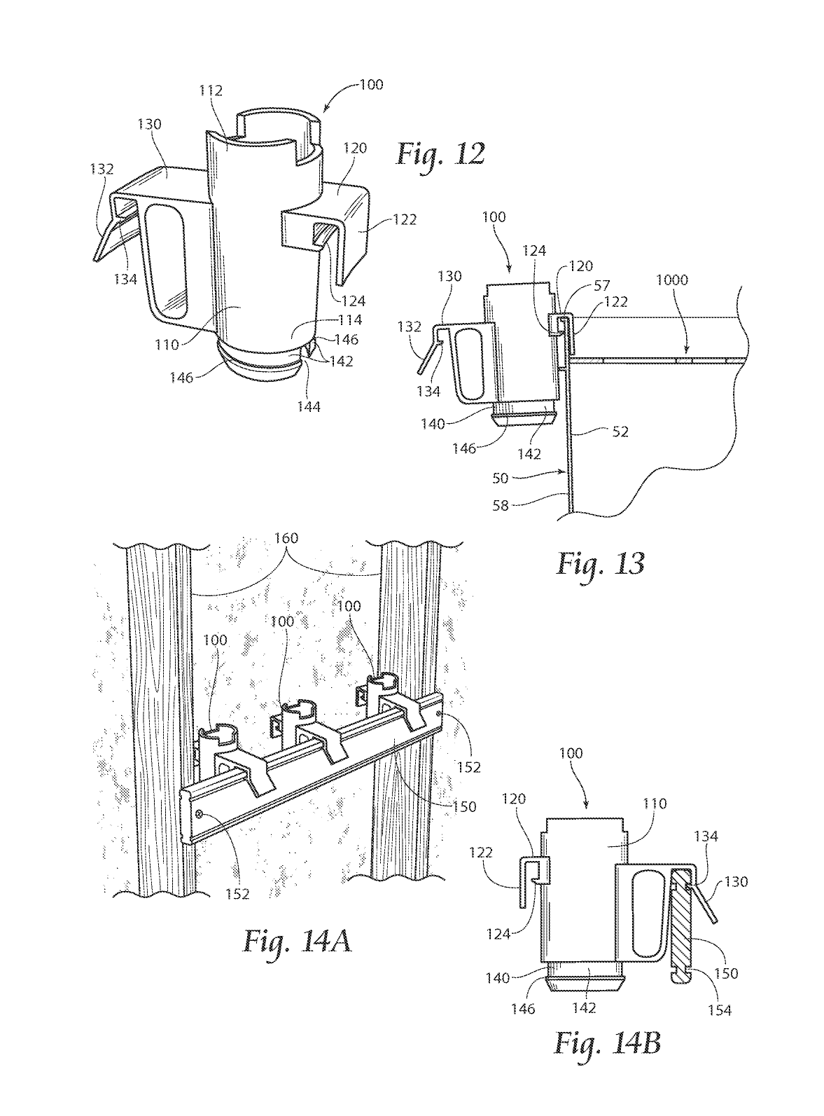

With reference now to FIGS. 12-16, a rod holder 100 for use with the present system is shown. As may be seen, the rod holder 100 preferably includes a cylindrical body 110 having two oppositely disposed ends 112 and 114 for receiving a fishing pole 44 or other elongate item, a first clip 120 for attaching the holder 100 to the rim 57 of the pail 50, a second clip 130 for attaching the holder 100 to a wall mount 150, and a third clip 140 for attaching the holder 100 to a web 1000, 2000, 3000, 4000.

As may be seen particularly in FIGS. 13 and 15, in use the holder 100 may be attached to the rim 57 of the pail 50 by the first clip 120. The first clip 120 has a first tab 122 which abuts the inner surface 52 of the pail 50, and a protrusion 124 which makes contact with the exterior surface 58 of the pail 50. When installed, the protrusion 124 also acts as a stop against the rim 57 and deters the holder 100 from falling off of the pail 50. The holder 100 may be made from a polymer or other resilient material, including, but not limited to, metal. As the first tab 122 is pliable, it may bent so that the holder 100 may be easily installed and removed, yet capable of retaining its shape for reuse.

FIGS. 14A and 14B illustrate the holder 100 attached to a wall mount 150. Here, the second clip 130 is shown having a second. Lab 132 with a protrusion 134 interfacing with a channel 154 along the wall mount 150. Again, the material used in manufacturing the holder 100 is preferably of a pliable nature to thereby provide flexibility to allow the second clip 130 to bend slightly as it is installed on the wall mount 150. Flexibility also aids in easy removal when an upward pressure is applied to the second tab 132 and away from the wall mount 150.

The wall mount 150 may be installed. in any location between two upstanding members 160. For example, open walls having upstanding members 160 are very common in garages, storage sheds, and basements. The wall mount 150 may be secured to the upstanding members 160 using any number of securing means (shown here as screws 152) and, when combined with the holder 100, provides a place for storing fishing poles 44 (shown in FIG. 5) in an organized and convenient manner. As the wall mount 150 has channels 154 on both sides, the holder 100 may be mounted on either side of the wall mount 150, thereby allowing fishing poles 44 (shown in FIG. 5) to be stored within the wall space between the two upstanding members 160 and away from potential damage.

FIG. 16 depicts the holder 100 as inserted in a web 4000. With reference to FIG. 12, the third clip 140 comprises at least two resilient members 142 separated by a gap 144. When inserted into an aperture 22b in the web 4000, the two resilient members 142 bend towards each other allowing them to pass through the aperture 22b. Once through, the resilient members 142 retain their original shape, and a lip 146, located on each resilient member 142, abuts the web 4000 and prevents the holder 100 from falling out of the aperture 22b. To remove the holder 100 the two resilient members 142 are forced towards one another allowing them to pass back through the aperture 22b.

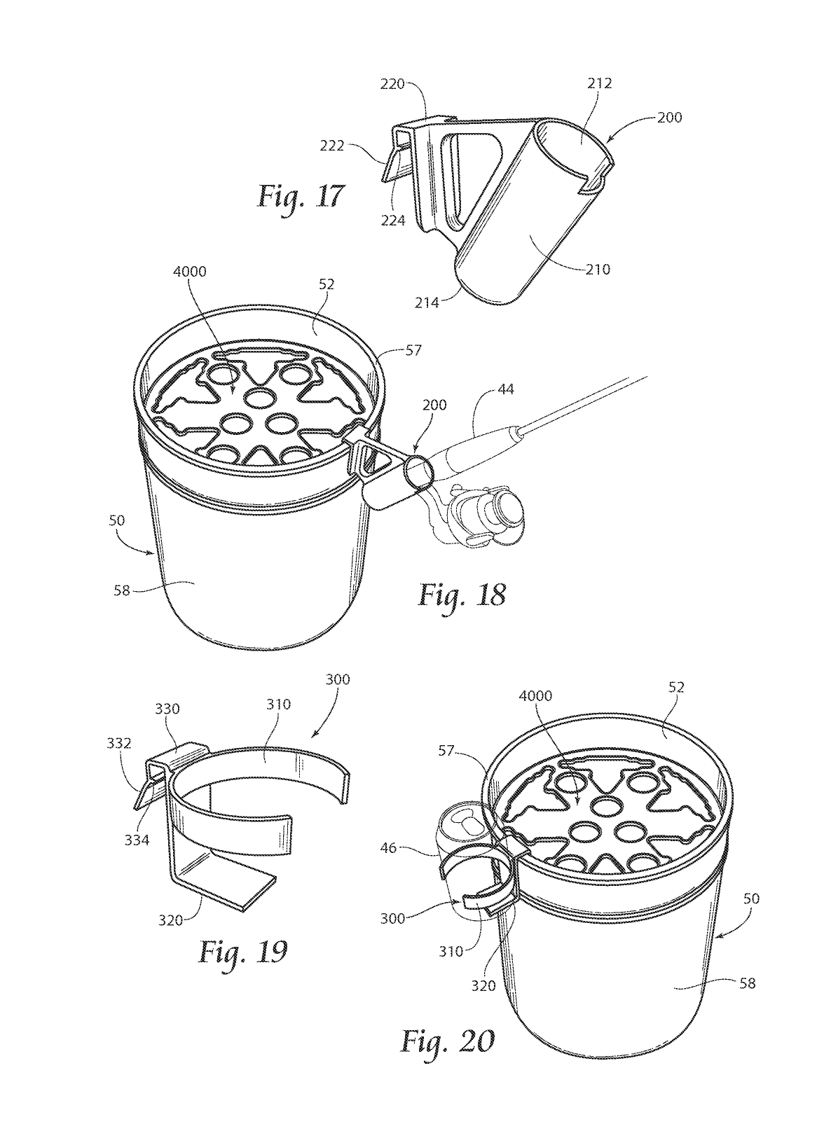

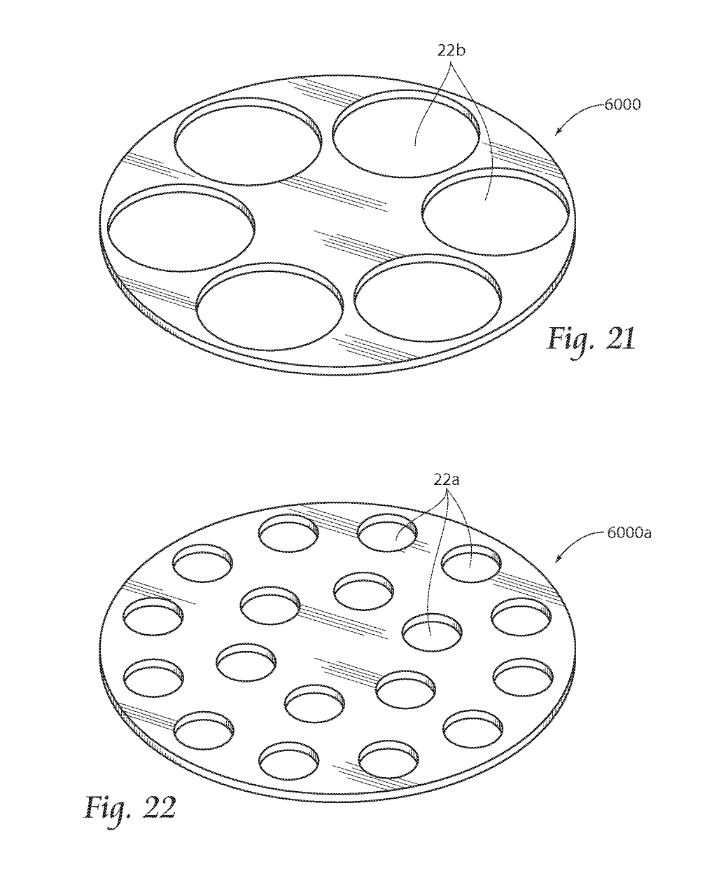

With reference to FIGS. 17 and 18, an angled rod holder 200 for use with the present system is shown. Similar to the rod holder 100 discussed. previously, the angled rod holder 200 comprises a cylindrical body 210 having two oppositely disposed ends 212 and 214 for receiving a fishing pole 41 or other elongate object, and a clip 220 having a tab 222 and a protrusion 224 for securing and releasing the angled holder 200 to the rim 57 of the pail 50. The angled holder 200 may also be attached to the previously described wall mount 150 (not shown).

FIGS. 19 and 20 illustrate a container holder 300 as contemplated by the present invention. The container holder 300 comprises a circumferential member 310, a platform 320, and a clip 330 having a tab 332 and a protrusion 334. The container holder 300 affixes to the rim 57 of the pail 50 or the wall mount 150 like the rod holder 100 and the angled rod holder 200. A container 46 may be placed within the circumferential member 310 and rested upon the platform 320 to provide a secure location for a container 46 off of the ground and easily accessible.

A system according to the present invention may include one or a plurality of webs 1000, 2000, 3000, 4000, 5000, 6000 and may further include a rod holder 100, 200, and a container holder 300.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A system for containing ice-fishing equipment in a tapered receptacle haying a circular cross section, the system comprising:
a first web comprising a first disc having a first plurality of apertures, the first disc having a substantially circular shape, a first outer periphery, and a first disc diameter; and
a second web comprising a second disc having a second plurality of apertures, the second disc having a substantially circular shape, a second outer periphery, and a second disc diameter, wherein the first disc diameter is larger than the second disc diameter.

2. The system of claim 1 wherein the first and second webs each include means for securing the webs inside the receptacle.

3. The system of claim 2 wherein the first plurality of apertures is alignable with the second plurality of apertures when the first web and the second web are secured within the receptacle.

4. The system of claim 1, wherein the first disc diameter and the second disc diameter differ and provide lateral spacing of the webs when the first web and the second web are secured within the receptacle.

5. The system of claim 1, wherein at least one of the first plurality of apertures and at least one of the second plurality of apertures is sized and configured to receive an elongate object.

6. The system of claim 5, wherein the elongate object is an ice fishing tip-up.

7. The system of claim 5, wherein the elongate object is a fishing pole.

8. The system of claim 1, further comprising a rod holder, said rod holder having a cylindrical body with a first end, and a first rod holder clip, said first rod holder clip adapted for removable attachment to a rim of the receptacle.

9. The system of claim 8, wherein the rod holder includes a second rod holder clip said second rod holder clip adapted for removable attachment to at least one of the first plurality of apertures.

10. The system of claim 1, further comprising a container holder having a container holder clip, said container holder clip adapted for removable attachment to a rim of the receptacle.

11. The system of claim 2 wherein said means for securing includes a plurality of teeth located on said first outer periphery and a plurality of teeth located on said second outer periphery.

12. The system of claim 2 wherein said means for securing includes a first channel located in said first outer periphery and a second channel located in said second outer periphery, wherein said first and second channels each include a bead therein.

13. The system of claim 2 wherein said means for securing includes a plurality of screw bosses located on said first outer periphery and a plurality of screw bosses located on said second outer periphery.

14. A kit to be used for transporting ice fishing equipment, said kit comprising:
a first web comprising a first disc having a plurality of apertures, the first disc having a substantially circular shape, a first outer periphery, and a first disc diameter;
a second web comprising a second disc having a plurality of apertures, the second disc having a substantially circular shape, a second outer periphery, and a second disc diameter; and
a tapered receptacle having a circular cross section.

15. The kit according to claim 14 further including a rod holder, said rod holder having a cylindrical body with a first end, and a first rod holder clip; and
a container holder, said container holder including a container holder clip.

16. A method for containing ice-fishing equipment in a tapered circular receptacle having a rim, the method comprising the steps of:
providing a first web, said first web comprising a first disc having a first plurality of apertures, the first disc having a substantially circular shape and a first disc diameter;
providing a second web, said second web comprising a second disc having a second plurality of apertures, the second disc having a substantially circular shape and a second disc diameter, wherein the first disc diameter is larger than the second disc diameter;
inserting the second web into the receptacle;
inserting the first web into the receptacle;
laterally spacing apart the first web from the second web; and
aligning the first plurality of apertures with the second plurality of apertures.

17. The method of claim 16 further including the steps of:
providing a rod holder, said rod holder having a cylindrical body, with a first end, and a first rod holder clip.

18. The method of claim 17 further including the step of removably attaching the first rod holder clip to the rim of the receptacle.

19. The method of claim 17 further including the steps of:
providing said rod. holder with a second rod. holder clip; and
removably attaching the second rod holder clip to one of said first plurality of apertures.

20. The method of claim 17 further including the steps of:
providing a container holder, said container holder having a container holder clip; and
removably attaching the container holder clip to a rim of the receptacle.
